(19) United States
(12) Patent Application Publication
(10) Pub. No.: US 2014/0209384 A1
(43) Pub. Date: Jul. 31, 2014

(54) METHOD AND SYSTEM FOR DETECTING CHANGES IN DRILLING FLUID FLOW DURING DRILLING OPERATIONS

(71) Applicant: Scott Alan Hanson, Bellaire, TX (US)

(72) Inventor: Scott Alan Hanson, Bellaire, TX (US)

(73) Assignee: Chevron U.S.A. Inc., San Ramon, CA (US)

(21) Appl. No.: 13/756,301

(22) Filed: Jan. 31, 2013

(51) Int. Cl. E21B 47/10; G01F 1/704

(52) U.S. Cl. CPC E21B 47/1015; G01F 1/704
USPC 175/42

(57) ABSTRACT

A method of detecting changes in return drilling fluid flow during drilling operations includes injecting at least one tracer gas at a measured rate into a return drilling fluid. A first sample of gases are extracted from the return drilling fluid at a location downstream of injection of the at least one tracer gas. A first concentration of the tracer gas in the first sample of gases is measured. A second sample of gases is extracted from the return drilling fluid at the location. A second concentration of the tracer gas in the second sample is measured. Changes in measured concentration of the tracer gas from the first and second samples are determined. The method includes using the change in measured concentration to infer a change in the flow rate.

### FIELD OF THE INVENTION

The present disclosure relates to a method and system for detecting changes in drilling fluid flow during drilling operations. In particular, the present disclosure describes a method of providing an early indication of a kick or fluid loss during drilling

### BACKGROUND OF THE INVENTION

In oil or gas well drilling operations, drilling fluid (e.g., “mud”) is continuously circulated through the inside of a drill pipe and out a drill bit into the wellbore, and subsequently back up an annulus (the space between the drill string and the walls of the wellbore or inside of casing string) to the surface. Drilling fluid is typically made up of clays, chemical additives and an oil or water base. This fluid has several purposes, including but not limited to: (1) controlling formation pressure; (2) cleaning the wellbore of formation debris; (3) lubricating, cooling, and cleaning the drill bit and drill string; (4) stabilizing the wellbore; and (5) limiting the loss of drilling fluid into the subsurface formation

During operations, controlling formation pressure typically includes providing drilling fluid to exert hydrostatic pressure greater than the pressure in the reservoir being drilled. If this is not maintained, and the pressure of the drilling fluid may drop below the formation pressure, which can lead to what is commonly referred to as a “kick.” This is where formation fluids move out of the formation and into the wellbore. If a kick is not recognized early and corrective action taken, the kick may lead to unintended flow of fluids from the formation.

Another challenge commonly encountered during drilling operations is “fluid loss.” This is where drilling fluid moves from the wellbore and into the formation. Although some fluid loss typically occurs during normal operations, too much pressure resulting from the fluid loss could result in unintended effects on the formation.

To minimize “kick” or “fluid loss” it is known to monitor: (1) changes in flow rate of drilling fluid flowing out the surface from the wellbore; (2) a change in volume of the drilling fluid in the mud pits holding the drilling fluid at the rig; and/or (3) changes in pump pressure and/or speed. However, such methods may be less than optimal.

Monitoring drilling fluid flow, for example, may include using various flow meters or measuring drilling fluid levels in the return tanks of the drilling rig for increases and decreases. The flow meters may not be sensitive enough to detect small changes in flow, and be difficult to set up on drilling rigs of various configurations.

Likewise, monitoring mud pits may not as sensitive to small increases in return mud flow rates.

Changes in pump pressure and speed could be indicative of other operating conditions, for example leakage in the drill string (a “washout”).

It is therefore desirable to provide a method of flow rate detection method that overcomes the shortcomings of the prior art.

### SUMMARY OF THE INVENTION

In a first aspect, the present disclosure provides a method of detecting changes in return drilling fluid flow during drilling operations, the drilling operation including pumping drilling fluid to a drill bit in a wellbore, and receiving return drilling fluid having dissolved formation gases at a wellhead of the wellbore, the method including the steps of: injecting at least one tracer gas at a measured rate into the return drilling fluid; extracting a first sample of gases from the return drilling fluid at a location downstream of injection of the at least one tracer gas; measuring a first concentration of the tracer gas in the first sample of gases; extracting a second sample of gases from the return drilling fluid at the location; measuring a second concentration of tracer gas in the second sample of gases; and determining a change in measured concentration of the tracer gas from the first and second samples; and using the change in measured concentration to infer a change in the flow rate of the return drilling fluid.

In accordance with one embodiment of the present invention, a decrease in measured concentration of tracer gas indicates an increase in fluid flow, and an increase in measured concentration of tracer gas indicates a decrease in fluid flow.

In one embodiment, there is provided a method of detecting a kick or fluid loss during drilling operations, wherein the method includes detecting changes in return drilling fluid flow described above, and wherein an increase in drilling fluid flow indicates a kick, and a decrease in drilling fluid flow indicates fluid loss.

In another aspect of the present disclosure, there is provided a drilling system including: a drill string including a drill bit for drilling a wellbore; a drilling fluid pump for pumping drilling fluid down the wellbore proximate to the drill bit, wherein at least some of the drilling fluid in the form of return drilling fluid having dissolved formation gases, is returned back up to a wellhead of the wellbore; a tracer gas injector for injecting a tracer gas at a constant rate into the return drilling fluid; a flow line for receiving the return drilling fluid with injected tracer gas; a gas extractor for extracting a sample of gases from the return drilling fluid received from the flow line; and gas analysis equipment to determine the concentration of tracer gas in the sample of gases.

In one form, the drilling system includes a data logging unit for recording the concentration of tracer gas sample of gases, and determining changes in concentration of the tracer gas from one or more previous measured concentration of the tracer gas, wherein a decrease in measured concentration of tracer gas indicates an increase in return drilling fluid flow, and an increase in measured concentration of tracer gas indicates a decrease in return drilling fluid flow.

In one form, the gas analysis equipment includes a gas chromatograph. The system may also include a vacuum air pump for providing extracted gases to the gas chromatograph at a constant flow rate.

In another form, the drilling system further includes a device for providing a notification when there is: a change in concentration of tracer gas in the extracted gas beyond a specified range or value; or an increase or decrease in return drilling fluid flow beyond a specified range or value.

In another aspect of the present disclosure, there is provided a method of detecting changes in return drilling fluid flow during drilling operations, the drilling operation including pumping drilling fluid to a drill bit in a wellbore, and receiving return drilling fluid at a wellhead of the wellbore, the method comprising the steps of: injecting at least one tracer gas for a first discrete time period into the return drilling fluid; detecting the tracer gas from the first discrete time period in the return drilling fluid at a location downstream of injection of the at least one tracer gas; measuring a first time delay between injection of the tracer gas at the first discrete time period and detection of the tracer gas from the first time period at the location; injecting tracer gas for a second discrete time period into the return drilling fluid; detecting the tracer gas from the second discrete time period in the return drilling fluid at the location; measuring a second time delay between injection of the tracer gas at the second time period and detection of the tracer gas from the second time period at the location determining a change in measured time delay between the first time delay and second time delay; and using the change in measured time delay to infer a change in the flow rate of the return drilling fluid.

In one form, this may be achieved by injecting the tracer gas in pulses into the return drilling fluid, to allow detection and monitoring of variation in flow rates.

### BRIEF DESCRIPTION OF THE DRAWINGS

FIG. 1 shows a simplified schematic of a drilling system of the present disclosure;

FIG. 2 is a diagram representing steps of a method of detecting kick or fluid loss; and

FIG. 3 is a hypothetical example of a log plot showing drilling depth, measured tracer gas concentrations, measured formation gas, and calculated drilling fluid flow rate.

### DETAILED DESCRIPTION OF THE EMBODIMENTS

Drilling System

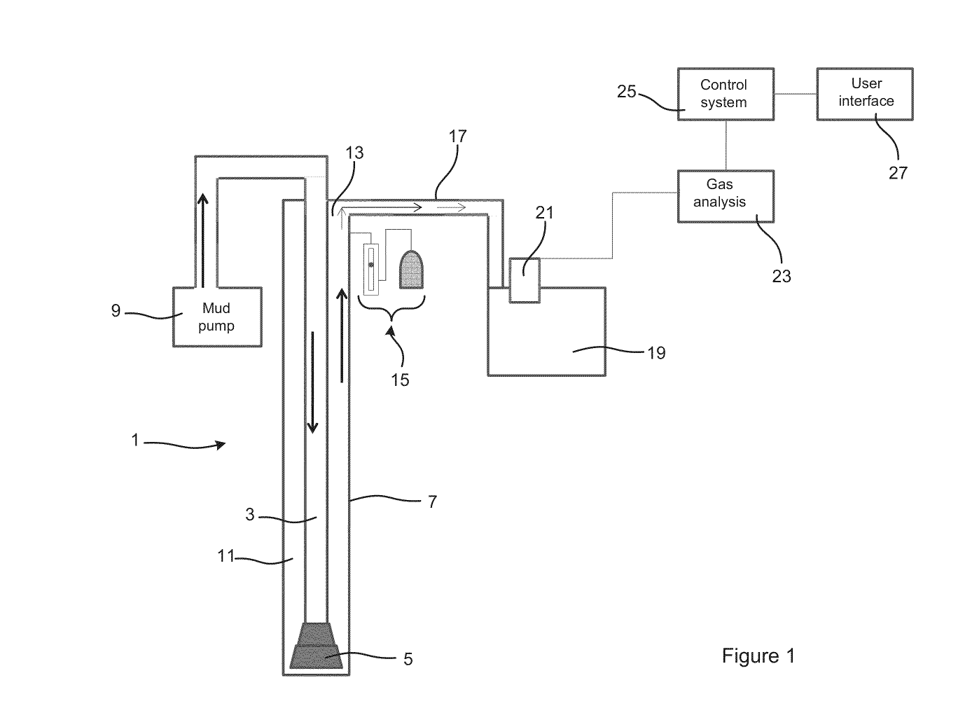

FIG. 1 illustrates a simplified schematic of a drilling system 1 according to a first embodiment. The drilling system 1 includes a drill string 3 with a drill bit 5 at one end for drilling a wellbore 7. A drilling fluid pump 9 pumps drilling fluid down the wellbore 7 via the drill string 3, where the drilling fluid is discharged at or proximate to the drill bit 5. The drilling fluid subsequently returns to a wellhead 13 of the wellbore 7 via an annulus 11 around the drill string 3. The return drilling fluid includes dissolved formation gases from the formation around the wellbore 7. A tracer gas injector 15 is provided to inject tracer gas at a measured rate into the return drilling fluid. The return fluid having the tracer gas is conveyed in a flow line 17, and subsequently a gas extractor 21 extracts a sample of tracer and formation gases from the return drilling fluid. The extracted gases, including the tracer and formation gases, are then provided to gas analysis equipment 23 for determining the concentration of tracer gas in the sample of extracted gases. A shale shaker 19 may be provided to remove cuttings and other solids from the return drilling fluid, and the return drilling fluid recycled to the drilling fluid pump 9 to be pumped down the wellbore 7. In one embodiment, the system 1 includes a monitoring or control system 25 for monitoring and/or controlling drilling operations. The monitoring or control system 25 receives data from the gas analysis equipment 23 and displays raw or processed data through a user interface 27.

Note, certain aspects of the present disclosure may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present disclosure may be coded in different languages for application in a variety of computing platforms and environments. It will be appreciated that the scope and underlying principles of the present invention are not limited to any particular computer software technology.

Also, an article of manufacture for use with a computer processor, such as a CD, pre-recorded disk or other equivalent devices, may include a computer program storage medium and program means recorded thereon for directing the computer processor to facilitate the implementation and practice of the present invention. Such devices and articles of manufacture also fall within the spirit and scope of the present disclosure.

The components of the drilling system 1 will now be described in detail. The drill string 3, drill bit 5, drilling fluid pump 9 and shale shaker 19 are known in the oil and gas drilling industry, and it is not necessary to discuss these components in further detail.

Tracer Gas Injector

The tracer gas injector 15 injects a tracer gas or tracer gases into the return drilling fluid. The injection point may be at or near the wellhead 13 where the return drilling fluid is received, or injected into the flow of return drilling fluid after the wellhead 13.

Ideally the tracer gas is introduced into the drilling fluid at a constant flow rate. This may be regulated by a gas meter to ensure the tracer gas is introduced as a constant volume of gas over time (e.g. liters of gas per minute). In one embodiment, it may be desirable to maintain constant pressure and/or temperature of the tracer gas being introduced to ensure a constant mass flow rate of tracer gas. Alternatively, a constant mass flow rate may be maintained by measuring parameters including pressure, temperature, velocity of gas flow, volume of gas introduced over time etc, and calculating required adjustments required to keep the mass flow of gas into the return drilling fluid constant.

The tracer gas is ideally a gas that does not exist, or does not exist in substantial amounts, in the formation being drilled. That is, the tracer gas should not be selected from a gas that is found in the formation gases. The tracer gas is selected from gases that can be measured by the gas analysis equipment 23 (described below).

In one embodiment, acetylene may be a suitable tracer gas. As an example, acetylene as a tracer gas may be introduced at a rate of 3 liters per minute.

It may be advantageous to inject the gas using a gas sparger (bubbling porous metal injector) to ensure the tracer gas is substantially distributed and/or dissolved throughout the return drilling fluid.

Flow Line

The flow line 17 allows tracer gas to be conveyed to the gas extractor 21 and/or shale shaker 19. The flow line 17 in one embodiment may be a pipe. It may be advantageous for the flow line 17 to include a flow path of sufficient length to ensure the tracer gas is substantially distributed and/or dissolved throughout the return drilling fluid. Gas extractor

The gas extractor 21 extracts a sample of gas, which includes both the tracer and formation gases from the return drilling fluid. This may involve diverting a small sample amount of return drilling fluid through an enclosed volume, and then mechanically agitating the return drilling fluid to extract the dissolved gases from the return fluid.

In one embodiment the gas extractor 21 extracts a sample before the return drilling fluid passes the shale shaker 19 screens. The gas extractor 21 sits in the header tank or “possum belly” of the shale shaker 19. Drilling fluid flows into the header tank from the flow line 17 and then flows over the screens on the shale shaker 19.

The sample of gas taken by the gas extractor from the header tank is then conveyed to the gas analysis equipment for measurement and data logging. The sample of gas may be continuously drawn from the gas extractor, ideally at a constant flow rate, to the gas analysis equipment. This may include using a vacuum pump to draw the sample gas.

It is desirable to utilize a stable gas extractor to ensure usefulness of the data. The gas measurement and analysis system may include a Quantitative Gas Measurement (QGM™) gas trap. The QGM gas trap is designed to prevent uncontrolled gas/air mixing at the mud exit and agitator feed through. This modification stabilizes the gas trap readings by preventing uncontrolled dilution of the gas sample caused primarily by wind blowing into the gas trap. Another source of gas trap instability is sensitivity to immersion level. Gas traps basically work as centrifugal pumps, and when lowered deeper into the drilling fluid will pump more mud. This change in the volume of mud moving through the gas trap may affect the gas values. Internal baffles and a pyramidal agitator design maintain a stable gas trap response over a range of about 5 inches of immersion level change. Other sources of gas trap instability are motor speed and sample rate. An agitator speed of 1750-1725 RPM is recommended for the QGM gas trap and this speed should be maintained in order to ensure consistent gas values. Sample rate, which is the volume of gas/air pulled from the gas trap into the logging unit for analysis, should ideally be kept constant to ensure consistency. For the QGM gas trap a volume of 12 CFH for water base mud and 6 CFH for oil base mud systems is recommended.

Gas Analysis Equipment

The gas analysis equipment 23 allows measurement and/or calculation of the tracer gas concentration in the sample of extracted gases from the gas extractor 21. The gas analysis equipment 23 may includes a gas chromatograph to determine the concentration of tracer gas. The gas chromatograph separates the gas samples into its different components inside a column. The separated gas is then measured using a flame ionization or thermal conductivity detector. The information on the tracer gas concentration is then logged.

The information on the tracer gas concentration may, in real-time, be compared to the logged tracer gas concentrations from one or more previous measurements/calculations. The change in tracer gas concentration is indicative of a change in fluid flow rate of the return drilling fluid. In particular, a decrease in concentration of tracer gas is indicative of an increase in return drilling fluid flow, and an increase in concentration of tracer gas is indicative of a decrease in return drilling fluid flow. This information may be processed by a computer, or a control system 25 with a computer, and displayed as an output on a user interface 27.

If the calculated change in return fluid flow increases, it indicates there may be a “kick”, and if the calculated change is a decrease, it indicates there may be “fluid loss” in the wellbore 7.

A notification device may be provided, which generates a notification if the concentration of tracer gas in the extracted gases are outside a specified range of values. The range of specified values may correlate to operating conditions where it is unlikely to be a condition of a “kick” or “fluid loss”.

Alternatively, the notification device may provide notifications based on the inferred or calculated flow rate (which in turn include the measured concentration of gases as a parameter). That is, the notifications may be triggered when the calculated flow rate, or calculated change in flow rate are outside a range of specified values.

The notification device may be part of the gas analysis equipment 23. Alternatively, the notification device may be a separate device, which receives information on tracer gas concentration or return fluid flow rates from the gas analysis equipment 23. This separate device may be part of a control system 25 and/or a user interface 27.

Monitoring or Control System and User Interface

The drilling system 1 may include a monitoring or control system 25 that is programmed to supervise the drilling operations. The monitoring or control system 25 typically includes at least one computational device, which may be a microprocessor, a microcontroller, a programmable logical device or other suitable device. Instructions and data to control operation of the computational device may be stored in a memory which is in data communication with, or forms part of, the computational device. Typically, the monitoring or control system 25 includes both volatile and non-volatile memory and more than one of each type of memory. The instructions and data for controlling operation of the system 1 may be stored on a computer readable medium from which they are loaded into the memory. Instructions and data may be conveyed to the control system by means of a data signal in a transmission channel. Examples of such transmission channels include network connections, the internet or an intranet and wireless communication channels.

The monitoring or control system 25 is typically in data communication with a user interface 27 that allows users to enter information into the monitoring or control system and also includes displays to enable users to monitor the operation of the drilling system 1. The monitoring or control system is in data communication with the other parts of the drilling system 1, which may include the drilling fluid pump 9, blow-out preventer (not shown), and the tracer gas injector 15.

The control system 25 may, for example, be a SCADA system, which provides system control and data acquisition.

Where such instrumentation is provided, the data generated by the instrumentation may be displayed locally in the vicinity of the instruments. Alternatively or in addition, the data may be provided to the control system 25 for display on the user interface 27 and storage in memory.

Operation

The operation of the drilling system 1 in particular the method of detecting early kick or fluid loss will now be described.

General Operation of the Drilling System

The general drilling operation includes drilling with the drilling bit 5 down the wellbore 7, whilst the drilling fluid is pumped by the pump 9, down the drill string 2 towards the drill bit 5. The drilling fluid then returns upwards towards the wellhead, where tracer gas is introduced. The drilling fluid then passes through a shale shaker 6 to remove solids, and a gas extractor 7 removes a sample of gas from the drilling fluid. The extracted gas is then analyzed (as discussed in further detail below). The return drilling fluid may flow to the mud pit, and subsequently circulated back to the fluid pump 1.

Analysis of Gases to Detect Early Kick or Fluid Loss

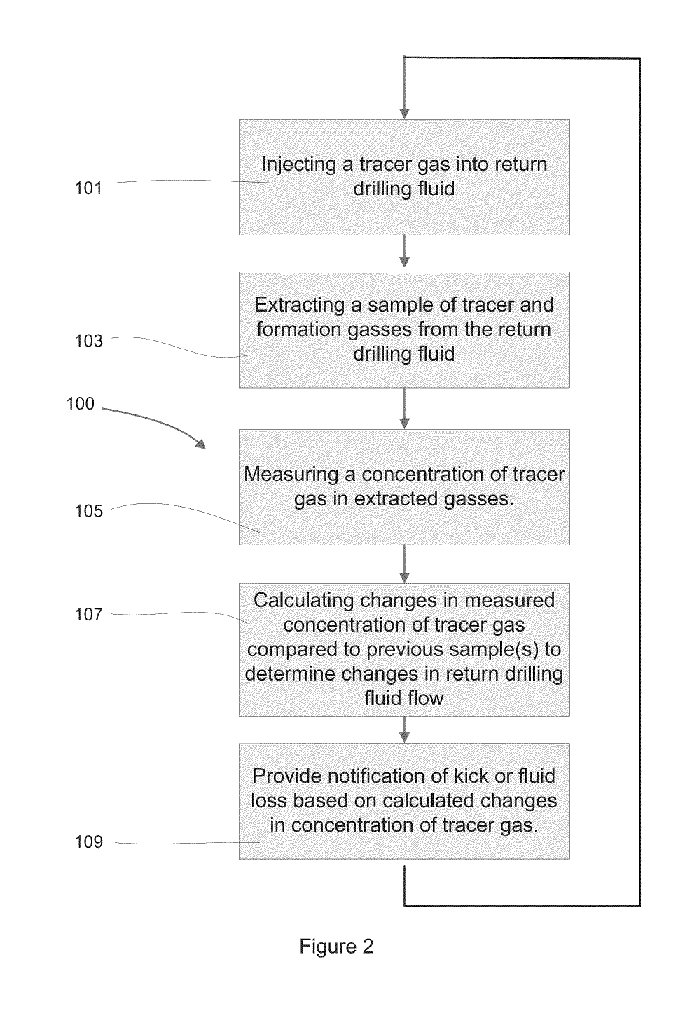

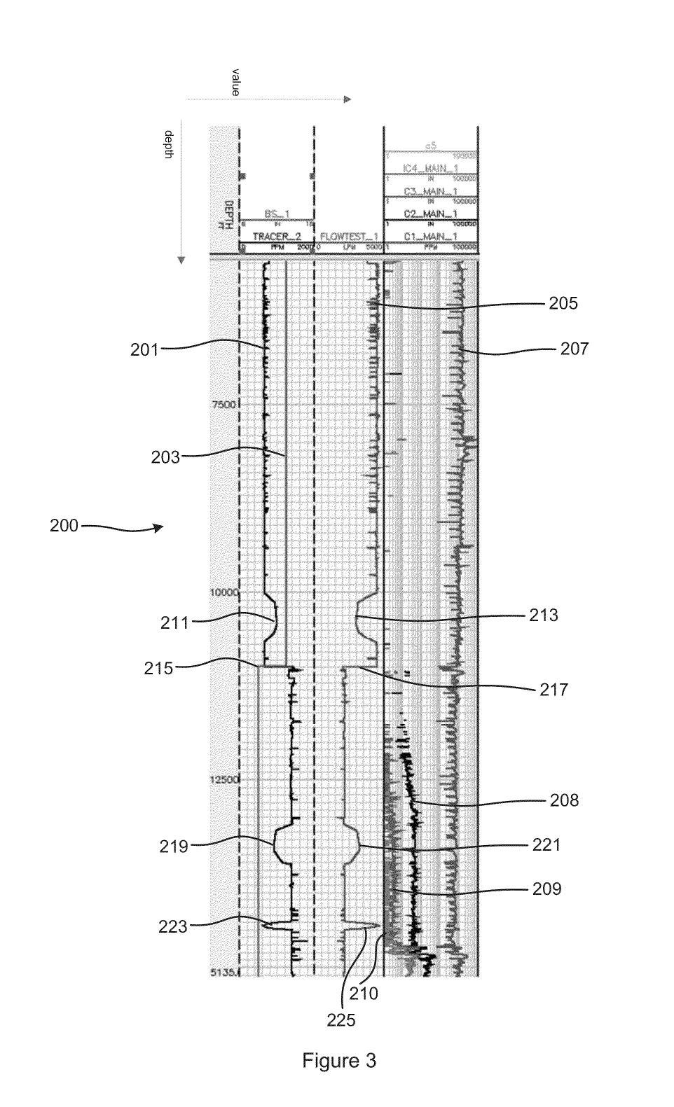

The method of detecting early kick or fluid loss will now be described in detail with reference to FIGS. 2 and 3.

FIG. 2 illustrates the steps of the method 100 of providing notification of kick or fluid loss. It is to be appreciated these steps are ideally performed concurrently and continuously by respective parts of the drilling system 1.

The first step 101 is to inject a tracer gas into the return drilling fluid, which in the system shown in FIG. 1 is proximal to the wellhead.

The subsequent step 103 is to extract a sample of tracer and formation gases from the return drilling fluid. The extracted sample of gas is then provided to the gas analysis equipment for measurement.

The following step 105 is to measure the concentration of tracer gas in the sample of tracer and formation gases.

The next step 107 is to calculate the changes in measured concentration of tracer gas compared to one or more previous samples. If there is a decrease in measured concentration of tracer gas, this indicates an increase in fluid flow. Alternatively, if there is an increase in measured concentration of tracer gas, this indicates a decrease in fluid flow.

The next step 109 is to provide notification of kick or fluid loss, based on the changes in measured tracer gas concentration beyond a specified range or value. This may be directly related to changes in concentration of tracer gas beyond a specified range or value. Alternatively this may be through calculation of the return flow rate or change in return flow rate calculated from the measured concentration of tracer gas, and providing a notification when the return flow rate or change in return flow rate is beyond a specified range or value.

This notification of a kick or fluid loss allows the drilling crew more time to react to a potential drilling hazard. This may include changing the mud weight, or preparation for engagement of blow-out preventers.

In one form, the notification could be delivered at a control panel or other user interface 27 for the operators. Alternatively, the notification could be provided to an automated control system 25 which may automatically respond, or prepare to respond to the potentially hazardous condition. The notification may be provided by an audible noise, a flashing light, or other indicator on the control panel.

### EXAMPLE

A hypothetical example will now be described with reference to FIG. 3 which shows a log plot 200 of various measurements and calculated values. In this example, the tracer injection rate is 3 liters per minute.

The measured tracer values are provided by tracer line 201. The drill bit size line 203 indicates the size of the drill bit used at the corresponding depths. The calculated drilling fluid flow, based on the measured tracer values, is provided by flow rate line 205. The measured formation gas concentrations are provided by formation gas lines 201, 208, 209, 210.

The first notable feature on tracer line 201 is an increase in tracer value 211. This increase in turn reflects a calculated decrease in flow rate 213 on flow rate line 205. This indicates a possible fluid loss interval in drilling.

The next notable feature is a step jump 215, 217 on the respective tracer line 201 and flow rate line 205. This corresponds to a change to a smaller bore hole size (as shown by drill bit size line 203 near step 215) and lower pump rate. The tracer injection rate however did not change.

The tracer line 201 dips at tracer value 219, which has a corresponding increase in flow rate 221. This shows a possible fluid flow into the wellbore, i.e. a possible kick. A similar feature is shown at 223 and 225.

Formation gas lines 207, 208, 209, 210 show the formation gases typically measured during drilling. It is clear that some variation of gases may occur at different depths. For example formation gas line 208 (representing ethane), 209 (representing propane), 210 (representing iso butane) appear in much higher concentration at lower depths. However formation gas line 207 (representing methane) shows relatively consistent concentration at various depths. Despite some variation in concentration of formation gas values, inference of changes in return drilling fluid flow can still be achieved by compensating for the changes in formation gas concentration, as discussed below.

Variations

In another embodiment, the introduction of tracer gas may not be at an exact constant rate. However, by measuring temperature, pressure, velocity, and volume of gas introduced over time, and logging this information, it may allow calculation of the mass of tracer gas introduced during particular time periods. This information may allow adjustments or compensation to the tracer gas concentration values measured at the gas analysis equipment when determining whether there is an increase or decrease fluid flow of the drilling fluid.

Similarly if the dissolved formation gases in the return drilling fluid per volume (or mass) of drilling fluid varies over time, it may be possible to log information regarding such variation, and to use this information to adjust or compensate the measured values to provide a more accurate determination of variations in fluid flow of the drilling fluid.

In another variation of the method of detecting changes in drilling fluid flow, changes to the flow rate of the return drilling fluid may be inferred by measuring changes in the time delay from injection of a tracer gas into the return drilling fluid, and detection of the injected tracer gas in the return drilling fluid downstream of the point of injection.

After receiving the return drilling fluid at the wellhead 13 of the wellbore 7, the tracer gas injector 15 injects tracer gas for a first discrete time period into the return drilling fluid. The return drilling fluid then flows through flow line 17. At a location downstream of the gas injector 15, the tracer gas injected during the first discrete time period is detected. This may be achieved, for example by a combination of the gas extractor 21 located at or near the location, and the gas analysis equipment 23. A first time delay between injection of the tracer gas at the first discrete time period and detection of the tracer gas from the first discrete time period at the location is measured, which may be done with the assistance of the monitoring or control system 25.

After injection of the tracer gas for the first discrete time period, the gas injector 15 injects tracer gas for a second discrete time period into the return drilling fluid. Subsequently, the tracer gas from the second discrete time period is detected. A second time delay between injection of the tracer gas at the second discrete time period and detection of the tracer gas from the second discrete time period at the location is measured.

A change in the measured time delay between the first time delay and the second time delay is then determined. Using the change in the measured time delay, a change in the flow rate of the return drilling fluid can be inferred. The steps of determining the change in measured time delay and inferring a change in flow rate of the return drilling fluid may be performed by the monitoring or control system 25.

In a further embodiment of the above described variation, the gas injector 15 injects the tracer gas in pulses into the return drilling fluid to allow detection and monitoring of variations in flow rates.

It will be understood that the invention disclosed and defined in this specification extends to all alternative combinations of two or more of the individual features mentioned or evident from the text or drawings. All of these different combinations constitute various alternative aspects of the invention.

What is claimed is:

1. A method of detecting changes in return drilling fluid flow during drilling operations, the drilling operation including pumping drilling fluid to a drill bit in a wellbore, and receiving return drilling fluid having dissolved formation gases at a wellhead of the wellbore, the method comprising the steps of:
injecting at least one tracer gas at a measured rate into the return drilling fluid;
extracting a first sample of gases from the return drilling fluid at a location downstream of injection of the at least one tracer gas;
measuring a first concentration of the tracer gas in the first sample of gases;
extracting a second sample of gases from the return drilling fluid at the location;
measuring a second concentration of the tracer gas in the second sample of gases; and
determining a change in measured concentration of the tracer gas from the first and second samples; and
using the change in measured concentration to infer a change in the flow rate of the return drilling fluid.

2. A method according to claim 1, wherein a decrease in measured concentration of tracer gas indicates an increase in fluid flow, and an increase in measured concentration of tracer gas indicates a decrease in fluid flow.

3. A method according to either claim 1 or 2 wherein measuring the concentration of the tracer gas is performed by analyzing the samples of gases with a gas chromatograph.

4. A method according to claim 3 further comprising the step of providing the samples of gases to the gas chromatograph at a constant flow rate using a vacuum air pump.

5. A method according to any one of the preceding claims, wherein the tracer gas is acetylene.

6. A method of detecting a kick or fluid loss during drilling operations, the method comprising:
detecting changes in return drilling fluid flow according to claim 1;
wherein an increase in drilling fluid flow indicates a kick, and a decrease in drilling fluid flow indicates fluid loss.

7. A drilling system comprising:
a drill string including a drill bit for drilling a wellbore;
a drilling fluid pump for pumping drilling fluid down the wellbore proximate to the drill bit, wherein at least some of the drilling fluid in the form of return drilling fluid having dissolved formation gases, is returned back up to a wellhead of the wellbore;
a tracer gas injector for injecting a tracer gas at a constant rate into the return drilling fluid;
a flow line for receiving the return drilling fluid with injected tracer gas;
a gas extractor for extracting a sample of gases from the return drilling fluid received from the flow line; and
gas analysis equipment to determine the concentration of tracer gas in the sample of gases.

8. A drilling system according to claim 7, further comprising:
a data logging unit for recording the concentration of tracer gas in the sample of gases, and determining changes in concentration of the tracer gas from one or more previous measured concentration of the tracer gas,
wherein a decrease in measured concentration of tracer gas indicates an increase in return drilling fluid flow, and an increase in measured concentration of tracer gas indicates a decrease in return drilling fluid flow.

9. A drilling system according to claim 7, further comprising:
a shale shaker for removing solid particles from the return drilling fluid after flowing past the gas extractor.

10. A drilling system according to claim 7 wherein the tracer gas is acetylene.

11. A drilling system according to claim 7, wherein the gas analysis equipment comprises:
a gas chromatograph.

12. A drilling system according to claim 11 further comprising:
a vacuum air pump for providing extracted gases to the gas chromatograph at a constant flow rate.

13. A drilling system according to any one of claims 7 to 12 further comprising:
a device for providing a notification when there is a change in concentration of tracer gas in the extracted gas beyond a specified range or value.

14. A drilling system according to any one of claims 7 to 12 further comprising:
a device for providing a notification when there is an increase or decrease in return drilling fluid flow beyond a specified range or value.

15. A method of detecting changes in return drilling fluid flow during drilling operations, the drilling operation including pumping drilling fluid to a drill bit in a wellbore, and receiving return drilling fluid at a wellhead of the wellbore, the method comprising the steps of:
injecting at least one tracer gas for a first discrete time period into the return drilling fluid;
detecting the tracer gas from the first discrete time period in the return drilling fluid at a location downstream of injection of the at least one tracer gas;
measuring a first time delay between injection of the tracer gas at the first discrete time period and detection of the tracer gas from the first time period at the location;
injecting tracer gas for a second discrete time period into the return drilling fluid;
detecting the tracer gas from the second discrete time period in the return drilling fluid at the location;
measuring a second time delay between injection of the tracer gas at the second time period and detection of the tracer gas from the second time period at the location;
determining a change in measured time delay between the first time delay and second time delay; and
using the change in measured time delay to infer a change in the flow rate of the return drilling fluid.

16. A method according to claim 15 wherein the steps of injecting the tracer gas is repeated such that the tracer gas is injected into the return drilling fluid in pulses to allow detection and monitoring of variations in return drilling fluid flow rates.
